(19) United States
(12) Patent Application Publication
(10) Pub. No.: US 2026/0067387 A1
(43) Pub. Date: Mar. 5, 2026

(54) Scalable Mobile Phone Case

(71) Applicants: Xijian Ma, Shaoguan City (CN); Ruihua Zhong, Boluo County (CN)

(72) Inventors: Xijian Ma, Shaoguan City (CN); Ruihua Zhong, Boluo County (CN)

(21) Appl. No.: 18/916,742

(22) Filed: Oct. 16, 2024

(30) Foreign Application Priority Data
Aug. 28, 2024 (CN) 2024221030434

(51) Int. Cl. H04M 1/02

(52) U.S. Cl. CPC H04M 1/026

(57) ABSTRACT

A scalable mobile phone case, comprising: an upper shell and a lower shell, wherein the upper shell and lower shell combine to form a cavity capable of holding a mobile phone. The upper shell has an upper connecting portion, and the lower shell has a lower connecting portion that interfaces with the upper connecting portion. The upper and lower connecting portions are connected via a sliding mechanism, enabling reciprocating sliding along the longitudinal axis of the mobile phone case. A torsion spring is positioned between the upper and lower connecting portions. Through the interaction between the upper and lower connecting portions, the upper and lower shells can slide relative to each other, allowing the case to switch between a separated state and a closed state. The elastic force of the torsion spring ensures that the upper and lower shells remain stable in either the separated or closed state.

### BACKGROUND OF INVENTION

### Field of the Invention

The present application relates to the field of mobile phone accessories, specifically to a scalable mobile phone case.

### Description of Related Art

In order to protect mobile phones, consumers typically purchase mobile phone cases (or covers) for protection. Common mobile phone cases are usually made of plastic materials and are integrally formed. These cases have cavities that fit closely with the phone to secure the case around the phone, providing protection against scratches and drops. The reason most mobile phone cases are currently made of plastic is that plastic materials have flexible properties, allowing easy assembly due to their ability to bend and deform. If hard materials such as metal are used for mobile phone cases, they cannot bend or deform. As a result, such materials cannot be used for integrally molded cases, as they cannot fit around the phone. To address this, mobile phone cases made of hard materials such as metal generally include a movable component that allows the case to be in an “open state.” After placing the phone in the case, the movable component closes the case, securing it around the phone.

Refer to Chinese Utility Model Patent No. CN202221251868.5, which discloses a buckle-type mobile phone case. Its technical solution involves a mobile phone case with a back cover and a middle frame, which are detachably connected via a buckle. The back cover is film-like, with a raised buckle piece at its edge perpendicular to the surface, and the buckle piece fits with the buckle seat inside the middle frame. The buckle-type phone case is divided into a back cover and a middle frame, and during installation, the back cover and middle frame are separated. After the phone is mounted on the middle frame, the back cover is attached, and the two are secured with a buckle. This structure is complex, and the separate middle frame and back cover require alignment during installation, which is not convenient to use.

Refer to Chinese Utility Model Patent No. CN202323254361.2, which discloses a scalable heat-dissipating mobile phone case. Its technical solution consists of a first half shell, a second half shell, and a connecting component. The first half shell is connected to the second half shell via the connecting component, forming a cavity that houses the phone. The first half shell and the second half shell can slide horizontally towards or away from each other to adjust the size of the cavity. Although this phone case is convenient to use, it has the following shortcomings: the first and second half shells are only connected by a bump and groove, relying on magnetic force for positioning. The connection strength is insufficient, and the first and second half shells may easily separate, causing the phone to fall out of the case under slight external force.

Based on the above, the inventor proposes the following technical solution.

### SUMMARY OF THE INVENTION

The objective of this utility model is to overcome the deficiencies of the prior art and provide a scalable mobile phone case that features a stable structure and is simple and convenient to operate.

To address the above technical problems, this utility model adopts the following technical solution: a scalable mobile phone case includes an upper shell and a lower shell made of hard materials. The upper shell and lower shell combine to form a cavity to house the phone. The upper shell has an upper connecting portion, and the lower shell has a lower connecting portion that interfaces with the upper connecting portion. The upper and lower connecting portions are connected via a sliding mechanism, enabling reciprocating sliding along the longitudinal axis of the case. A torsion spring is installed between the upper and lower connecting portions, providing elastic force to keep the upper and lower shells stable in either an open or closed state. The upper and lower shells achieve relative sliding through the interaction between the upper and lower connecting portions, enabling the case to remain stable in either a separated or closed state, with the torsion spring providing elastic force to maintain the stability.

In a further embodiment, the upper connecting portion extends from the lower end of the upper shell and has a plate-like shape. A step portion is formed between the upper connecting portion and the outer surface of the upper shell. The lower connecting portion is located on the inner surface of the lower shell, and the upper connecting portion slides along the inner surface of the lower shell into the lower connecting portion.

In another embodiment, the outer surface of the upper shell extends toward the upper connecting portion to form a guide protrusion, and a corresponding guide groove is formed in the lower shell. When the upper and lower shells are in a closed state, the guide protrusion fits into the guide groove.

In another embodiment, a positioning slider is provided on the outer surface of the upper connecting portion, and a corresponding positioning slide slot is located on the inner surface of the lower shell. The positioning slider and slide slot fit together to allow sliding.

In another embodiment, the upper connecting portion includes at least one set of positioning sliders symmetrically distributed along the centerline, with an upper groove formed on the side wall of the positioning slider. A lower groove that fits with the upper groove is formed on the inner side wall of the positioning slide slot, allowing the upper and lower grooves to nest together.

In another embodiment, the outer surface of the upper shell has uniformly distributed arc-shaped stripes.

In another embodiment, a sliding plate assembly, which includes a first sliding plate and a second sliding plate that can slide relative to each other, is used to install the torsion spring between the upper and lower connecting portions. The first sliding plate is fixed to the upper connecting portion, and the second sliding plate is fixed to the lower connecting portion. The torsion spring is positioned between the first and second sliding plates, with each end of the torsion spring connected to the first and second sliding plates, respectively.

In another embodiment, guide grooves are formed on both sides of the first sliding plate, and guide rails are formed on both sides of the second sliding plate to match the guide grooves.

In another embodiment, a protruding plate is formed at the lower end of the upper connecting portion, and a first positioning slot to house the first sliding plate is formed on the outer surface of the protruding plate. The first sliding plate is fixed in the first positioning slot using rivets or adhesive. A second positioning slot is formed on the inner surface of the lower connecting portion to house the second sliding plate, which is also fixed in place using rivets or adhesive.

In another embodiment, two torsion springs are placed between the first and second sliding plates, with each end of the torsion springs connected to the first and second sliding plates, respectively.

By adopting the above technical solution, compared to the prior art, this utility model has the following beneficial effects:

The present application uses hard materials such as metal, providing stronger impact resistance and abrasion resistance, thus offering better protection for the phone and longer service life.

The upper and lower shells are connected by a sliding mechanism, and the torsion spring provides elastic force to keep the case stable in either an open or closed state. When switching between the two states, the user only needs to apply a small external force to overcome the torsion spring's balance. The case will then automatically switch to the opposite state due to the torsion spring's force, making it very convenient to use.

To ensure stability and prevent the upper and lower shells from separating due to external forces, multiple sets of positioning sliders and slide slots are installed between the upper and lower connecting portions. These ensure smooth sliding while also keeping the shells connected, preventing separation during use.

To further enhance the structure and facilitate assembly, the torsion spring is installed within the sliding plate assembly, which is fixed to both the upper and lower connecting portions. This improves the connection between the upper and lower shells and facilitates later assembly, thus enhancing production efficiency.

### BRIEF DESCRIPTION OF THE DRAWINGS

FIG. 1 is a perspective view of the present application in the closed state;

FIG. 2 is a rear view of the present application in the closed state;

FIG. 3 is a cross-sectional view along line A-A in FIG. 2;

FIG. 4 is a cross-sectional view along line B-B in FIG. 2;

FIG. 5 is an exploded perspective view of the present application;

FIG. 6 is an exploded perspective view of the present application from another angle;

FIG. 7 is an exploded perspective view of the sliding plate assembly and torsion spring in the present application;

FIG. 8 is an exploded perspective view of the sliding plate assembly and torsion spring from another angle;

FIG. 9 is a schematic view of the working state of the sliding plate assembly and torsion spring in the present application;

FIG. 10 is a perspective view of the present application in the separated state;

FIG. 11 is a usage state diagram of another embodiment of the present application.

### DETAILED DESCRIPTION OF THE INVENTION

The present application will be further explained below in conjunction with specific embodiments and the accompanying drawings.

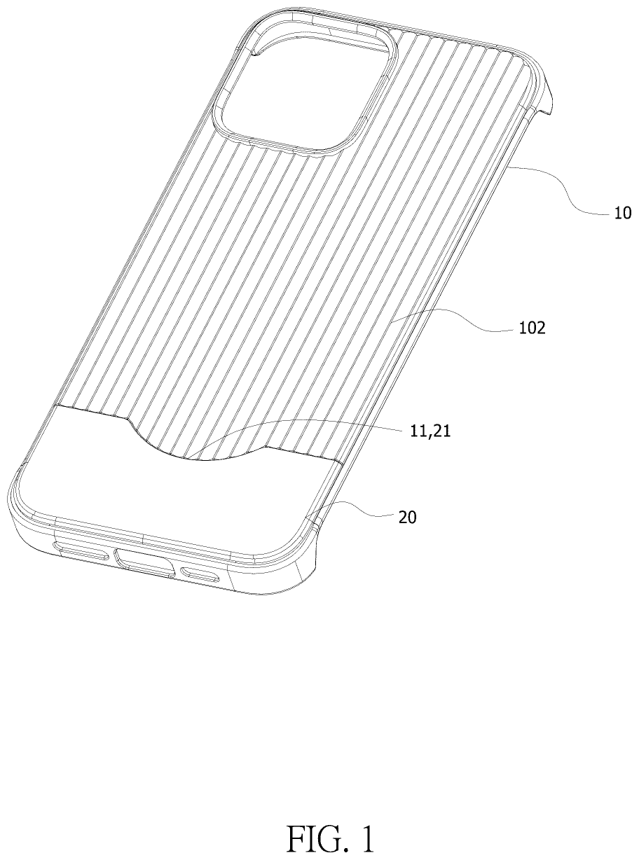

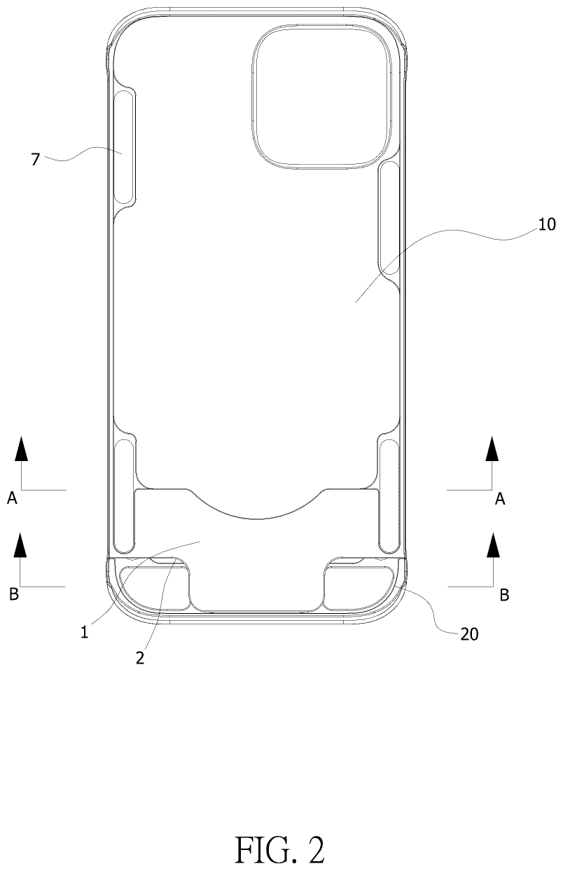

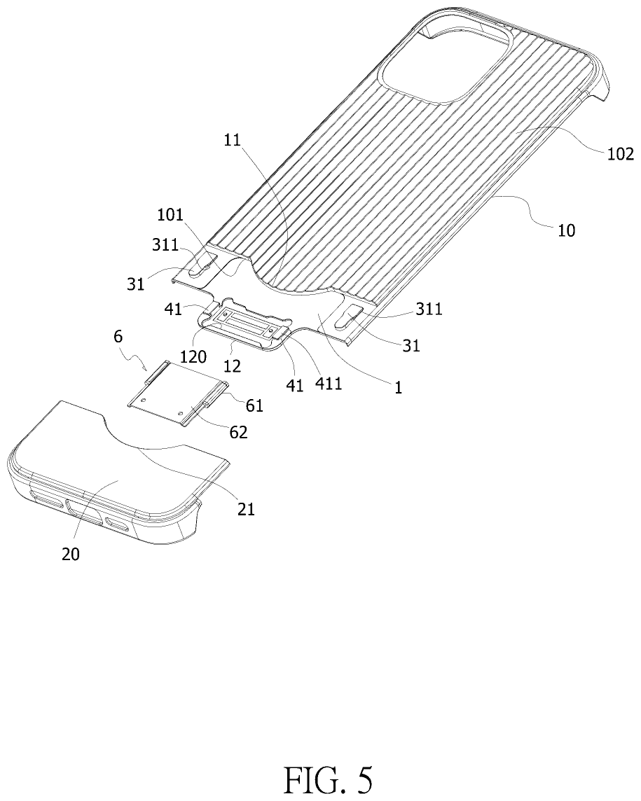

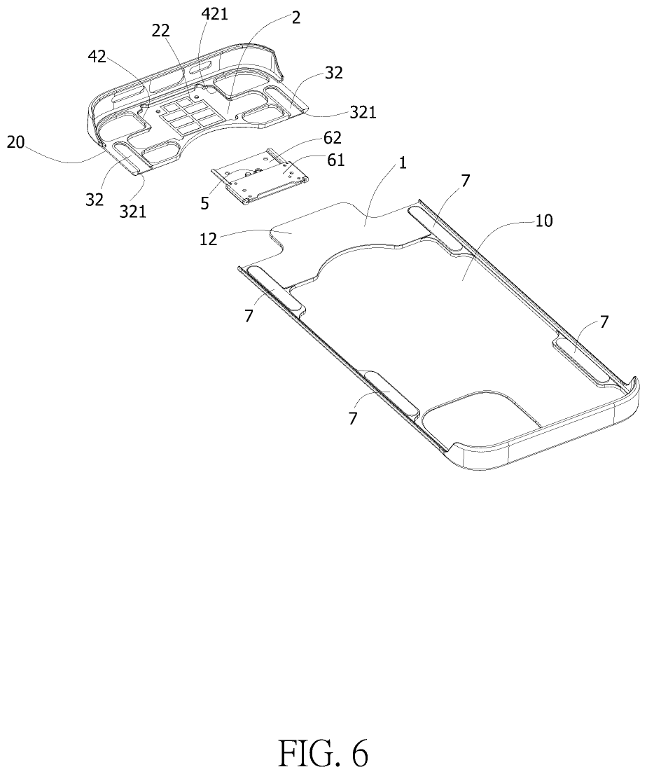

As shown in FIGS. 1 to 6, the present application is a scalable mobile phone case, which includes an upper shell (10) and a lower shell (20). Both the upper shell (10) and the lower shell (20) in this utility model are made of metal materials, such as aluminum alloy or other hard materials. The main bodies of the upper and lower shells are plate-like, with edges molded into frames. These upper and lower shell edges form a cavity capable of housing a phone.

The lower end of the upper shell (10) and the lower shell (20) meet at a connecting portion (1), which extends from the lower end of the upper shell (10) in a plate-like shape, forming a step portion (101) on the outer surface of the upper shell (10). The lower shell (20) has a lower connecting portion (2) that interfaces with the upper connecting portion (1) and is positioned on the inner surface of the lower shell (20). The upper connecting portion (1) slides along the inner surface of the lower shell (20) and fits into the lower connecting portion (2). After the upper and lower connecting portions interface, the lower shell (20) fills the gap created by the step portion (101).

The outer surface of the upper shell (10) has uniformly distributed arc-shaped stripes (102). These arc-shaped stripes (102) increase the surface area, further enhancing the heat dissipation effect of the mobile phone case, which is beneficial during phone usage. Rubber pads (7) are positioned along the edges of the inner surface of the upper shell (10). When the phone is assembled with the present application, these rubber pads (7) contact the back of the phone, providing protection and cushioning.

The upper connecting portion (1) and the lower connecting portion (2) are connected via a sliding mechanism, enabling reciprocating sliding along the longitudinal axis of the phone case. The upper shell (10) and lower shell (20) slide relative to each other through the engagement of the upper connecting portion (1) and lower connecting portion (2), allowing the phone case to remain in either a separated or closed state.

Specifically, the sliding connection between the upper connecting portion (1) and the lower connecting portion (2) adopts the following structure: a positioning slider is provided on the outer surface of the upper connecting portion (1), and a corresponding positioning slide slot is provided on the inner surface of the lower shell (20). The positioning slider and the slide slot fit together in a nested, slidable manner.

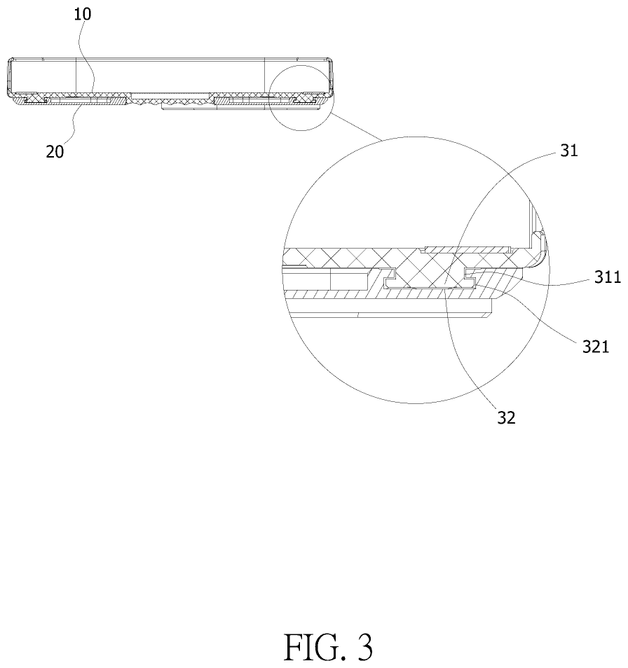

In this embodiment, the upper connecting portion (1) is equipped with two sets of four positioning sliders (31, 32) in total. Each set of positioning sliders is symmetrically distributed along the centerline of the longitudinal axis of the upper shell (10). Similarly, two sets of four positioning slide slots (32, 42) are provided on the inner surface of the lower connecting portion (2). Specifically, as shown in FIG. 3, the first set of two positioning sliders (31) is located near the outer edges of the upper connecting portion (1), and upper grooves (311) are formed on the left and right side walls of the positioning sliders (31). Correspondingly, positioning slide slots (32) are formed on the surface of the lower connecting portion (2) to match the positioning sliders (31), and lower grooves (321) are formed on the left and right inner side walls of the positioning slide slots (32) to nest with the upper grooves (311). The upper and lower grooves fit together in a nested manner.

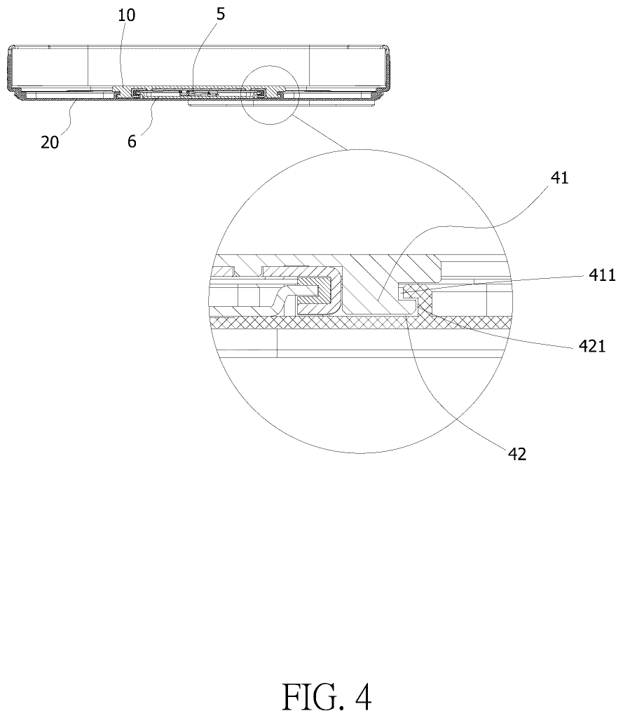

As shown in FIG. 4, the second set of two positioning sliders (41) is located near the center of the upper connecting portion (1), and upper grooves (411) are formed on the outer side walls of the positioning sliders (32). Correspondingly, positioning slide slots (42) are formed on the surface of the lower connecting portion (2) to match the positioning sliders (41), and lower grooves (421) are formed on the inner side walls of the positioning slide slots (42) to nest with the upper grooves (411). The upper and lower grooves fit together in a nested manner.

Through the nested fit of the two sets of positioning sliders (31, 32) and positioning slide slots (41, 42), relative sliding between the upper connecting portion (1) and the lower connecting portion (2) is achieved. The travel length of the positioning slide slots limits the sliding displacement, preventing complete separation. At the same time, the nested fit ensures that the upper and lower connecting portions remain connected and do not separate.

To further enhance guidance, a guiding protrusion (11) extends from the outer surface of the upper shell (10) towards the upper connecting portion (1). A corresponding guiding groove (21) is formed on the lower shell (20) to match the guiding protrusion (11). The guiding protrusion (11) and guiding groove (21) ensure proper alignment during assembly. When the upper shell (10) and the lower shell (20) are in the closed state, the guiding protrusion (11) and guiding groove (21) fit together, ensuring accurate alignment of the upper and lower shells.

The torsion spring (5) is installed between the upper connecting portion (1) and the lower connecting portion (2). The reason for adding the torsion spring (5) is to stabilize the sliding connection between the upper shell (10) and the lower shell (20) through the interaction of the upper connecting portion (1) and the lower connecting portion (2). This allows the upper shell (10) and lower shell (20) to remain stable in either a separated or closed state.

In this utility model, the torsion spring (5) can be directly positioned between the upper connecting portion (1) and the lower connecting portion (2), with both ends of the torsion spring (5) fixed to the upper and lower connecting portions, respectively.

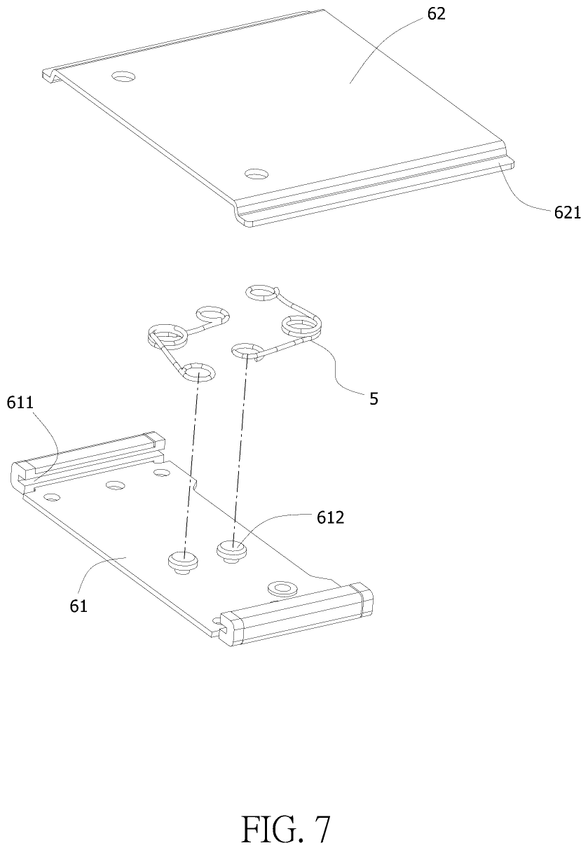

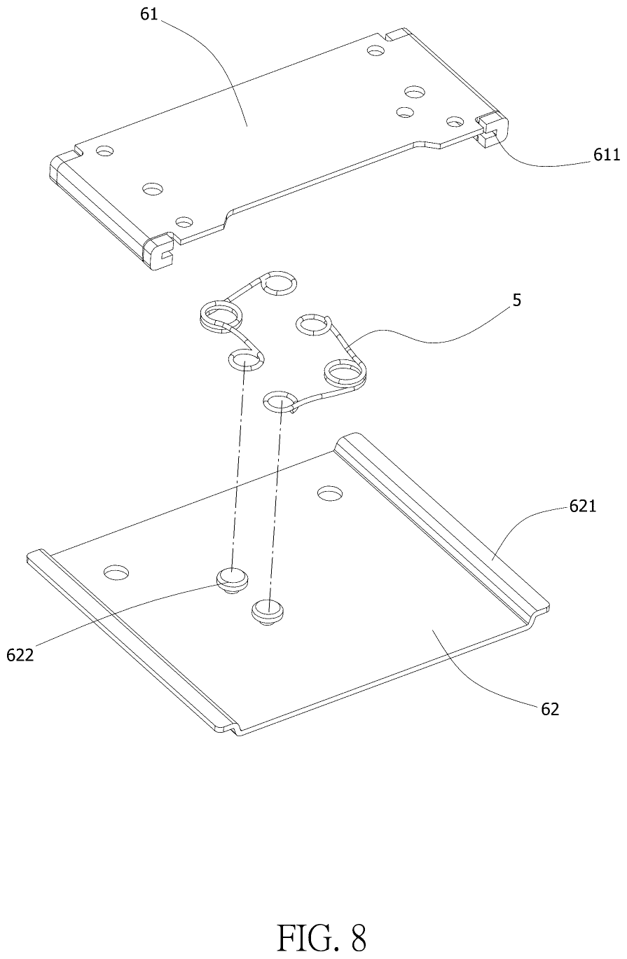

As shown in FIGS. 7 and 8, a preferred embodiment of this utility model places the torsion spring (5) within a sliding plate assembly (6). The torsion spring (5) is installed between the upper connecting portion (1) and the lower connecting portion (2) via the sliding plate assembly (6). Specifically, the sliding plate assembly (6) consists of a first sliding plate (61) and a second sliding plate (62) that can slide relative to each other. The first sliding plate (61) is fixedly connected to the upper connecting portion (1), while the second sliding plate (62) is fixedly connected to the lower connecting portion (2). Guide grooves (611) are formed on both sides of the first sliding plate (61), while guide rails (621) are formed on both sides of the second sliding plate (62). The relative sliding between the first sliding plate (61) and the second sliding plate (62) is achieved through the nesting of the guide grooves (611) and the guide rails (621). The torsion spring (5) is positioned between the first sliding plate (61) and the second sliding plate (62), with both ends of the torsion spring (5) connected to the respective sliding plates.

Additionally, to facilitate the installation of the sliding plate assembly (6) and minimize any thickness increase caused by the sliding plate assembly (6), a protruding plate (12) extends downward from the lower end of the upper connecting portion (1). A first positioning slot (120) is formed on the outer surface of this protruding plate (12) to house the first sliding plate (61), which is fixed in the first positioning slot (120) using rivets or adhesive. A second positioning slot (22) is formed on the inner surface of the lower connecting portion (2) to house the second sliding plate (62), which is similarly fixed in place using rivets or adhesive.

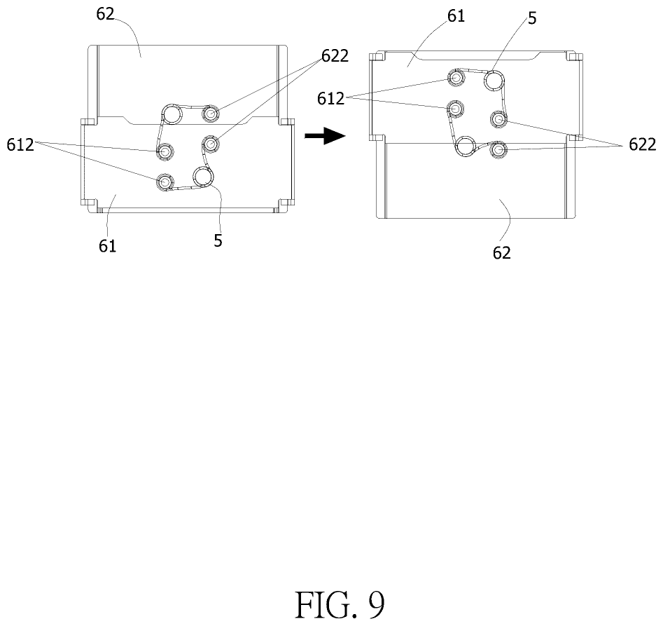

In this embodiment, two torsion springs (5) are symmetrically positioned between the first sliding plate (61) and the second sliding plate (62), with both ends of each torsion spring connected to the respective sliding plates. As shown in FIG. 9, when the first sliding plate (61) and the second sliding plate (62) slide relative to each other, the lower position of the first sliding plate (61) represents the closed state of the upper shell (10) and lower shell (20), while its upper position represents the separated state of the shells. The elastic force of the two torsion springs (5) allows for quick, automatic transitions between the separated and closed states, while ensuring that the sliding plates remain stable in either state until an external force (e.g., a user's push) disrupts the balance.

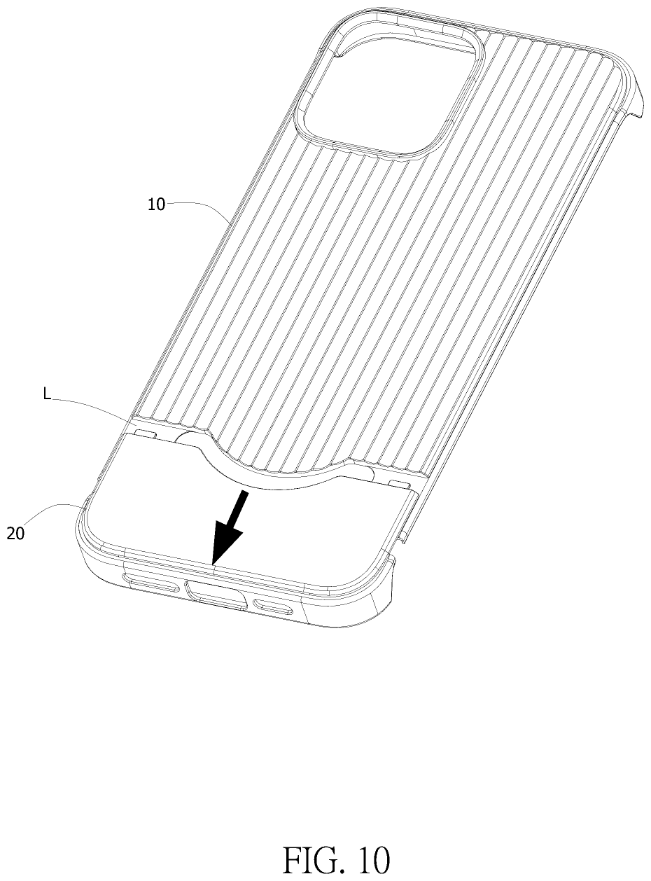

As shown in FIG. 10, when the upper shell (10) and lower shell (20) slide relative to each other through the connection of the upper and lower connecting portions (1 and 2), the phone case enters the separated state, creating a gap (L) between the two shells. This expansion allows for quick insertion of the phone into the case, after which external force can be applied to close the case, completing the assembly process.

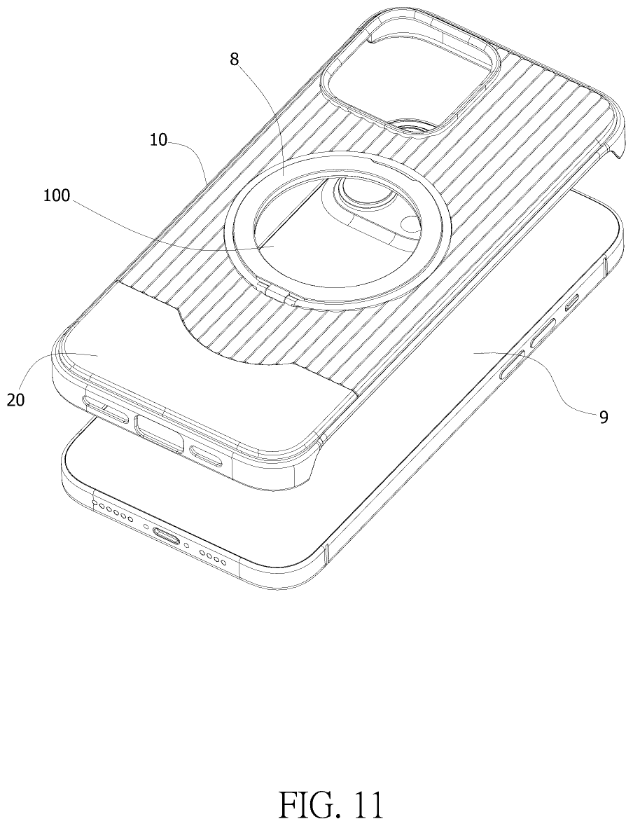

Since the present application typically uses metal materials such as aluminum alloy, it provides some degree of electromagnetic shielding, which may cause inconvenience for phones with wireless charging capabilities. To address this, the present application includes an improvement for wireless charging phones. As shown in FIG. 11, a through-hole (100) is opened in the upper shell (110) of the phone case. After assembling a wireless charging phone (9) with this embodiment, it can charge wirelessly through the through-hole (100), thus avoiding the electromagnetic shielding effect of the upper shell (10). Additionally, a ring-shaped phone stand (8) can be positioned around the through-hole (100), allowing users to prop the phone at an angle on a flat surface.

Of course, the above descriptions are only specific embodiments of the present application and are not intended to limit its scope. Any equivalent modifications or variations based on the structure, features, or principles described in the patent application should be included within the scope of the present application's patent claims.

We claim:

1. A scalable mobile phone case, comprising:
an upper shell (10) and a lower shell (20) made of hard materials, wherein the upper shell (10) and lower shell (20) combine to form a cavity for holding a mobile phone,
the upper shell (10) has an upper connecting portion (1), the lower shell (20) has a lower connecting portion (2) that interfaces with the upper connecting portion (1), and the upper connecting portion (1) and lower connecting portion (2) are slidably connected, enabling reciprocating sliding along the longitudinal axis of the mobile phone case;
a torsion spring (5) is provided between the upper connecting portion (1) and the lower connecting portion (2);
the upper shell (10) and lower shell (20) slide relative to each other through the interaction of the upper connecting portion (1) and the lower connecting portion (2), enabling the upper shell (10) and lower shell (20) to be in either a separated or closed state, and the torsion spring (5) provides elastic force to stabilize the upper shell (10) and lower shell (20) in either state.

2. The scalable mobile phone case according to claim 1, wherein the upper connecting portion (1) extends from the lower end of the upper shell (10) in a plate-like shape, and the upper connecting portion (1) forms a step portion (101) with the outer surface of the upper shell (10); the lower connecting portion (2) is located on the inner surface of the lower shell (20) and the upper connecting portion (1) slides along the inner surface of the lower shell (20) into the lower connecting portion (2).

3. The scalable mobile phone case according to claim 2, wherein the outer surface of the upper shell (10) extends in the direction of the upper connecting portion (1) to form a guiding protrusion (11), and the lower shell (20) forms a corresponding guiding groove (21) at the position matching the guiding protrusion (11) when the upper shell (10) and lower shell (20) are in the closed state.

4. The scalable mobile phone case according to claim 2, wherein a positioning slider is provided on the outer surface of the upper connecting portion (1), and a corresponding positioning slide slot is provided on the inner surface of the lower shell (20), and the positioning slider and positioning slide slot fit together in a slidable manner.

5. The scalable mobile phone case according to claim 3, wherein at least one set of positioning sliders symmetrically distributed along the centerline is provided on the upper connecting portion (1), and the sidewalls of the positioning sliders form upper grooves, and the inner sidewalls of the positioning slide slots form lower grooves that nest with the upper grooves.

6. The scalable mobile phone case according to claim 1, wherein the outer surface of the upper shell (10) is uniformly distributed with arc-shaped stripes (102).

7. The scalable mobile phone case according to any one of claims 1, wherein the torsion spring (5) is installed through a sliding plate assembly (6) between the upper connecting portion (1) and lower connecting portion (2);
the sliding plate assembly (6) comprises: a first sliding plate (61) and a second sliding plate (62) that can slide relative to each other, wherein the first sliding plate (61) is fixedly connected to the upper connecting portion (1), and the second sliding plate (62) is fixedly connected to the lower connecting portion (2);
the torsion spring (5) is positioned between the first sliding plate (61) and the second sliding plate (62), with both ends of the torsion spring (5) connected to the respective sliding plates.

8. The scalable mobile phone case according to claim 7, wherein the first sliding plate (61) has guide grooves (611) on both sides, and the second sliding plate (62) has guide rails (621) on both sides that match the guide grooves (611).

9. The scalable mobile phone case according to claim 7, wherein the lower end of the upper connecting portion (1) extends downward to form a protruding plate (12), and a first positioning slot (120) is formed on the outer surface of this protruding plate (12) to house the first sliding plate (61), and the first sliding plate (61) is fixed in the first positioning slot (120) using rivets or adhesive, and the inner surface of the lower connecting portion (2) forms a second positioning slot (22) to house the second sliding plate (62), and the second sliding plate (62) is fixed in the second positioning slot (22) using rivets or adhesive.

10. The scalable mobile phone case according to claim 7, wherein two torsion springs (5) are positioned symmetrically between the first sliding plate (61) and the second sliding plate (62).
